(19) United States
(12) Patent Application Publication
(10) Pub. No.: US 2026/0112720 A1
(43) Pub. Date: Apr. 23, 2026

(54) ADAPTIVE BATTERY CHARGING SYSTEM WITH DYNAMIC CURRENT ENHANCEMENT

(71) Applicant: MILWAUKEE ELECTRIC TOOL CORPORATION, Brookfield, WI (US)

(72) Inventors: Edward T. Cramer, Menomonee Falls, WI (US); Hadi A. Ahmed, West Allis, WI (US); Eli L. Zenz, Milwaukee, WI (US); Justin D. Saboury, Brookfield, WI (US); Sijia Zhou, Greenfield, WI (US)

(21) Appl. No.: 19/359,257

(22) Filed: Oct. 15, 2025

Related U.S. Application Data
(60) Provisional application No. 63/709,209, filed on Oct. 18, 2024.

(51) Int. Cl. H01M 10/44; H02J 7/00

(52) U.S. Cl. CPC H01M 10/443; H02J 7/94; H02J 7/96; H02J 7/975; H02J 2207/20

(57) ABSTRACT

A method of charging a battery pack includes receiving a current request, setting a charging setpoint based on the current request and a maximum output current; and configuring a converter based on the charging setpoint.

### RELATED APPLICATIONS

This application claims the benefit of U.S. Provisional Application No. 63/709,209, filed on Oct. 18, 2024, the entire contents of which are incorporated herein by reference.

### FIELD

Examples described herein generally relate to battery charging systems, and more particularly, to an adaptive charging method that dynamically enhances current delivery based on real-time measurements and communication between the charger and the battery pack.

### SUMMARY

Battery charging technology has evolved to accommodate various power sources and battery types. However, some charging methods face limitations when dealing with uncertain or variable power sources. For example, chargers may not know how much current they can provide to a battery pack until the output of the charger is measured. This uncertainty can lead to inefficient charging or potential safety issues.

Additionally, some power sources, like solar panels, may not accurately report actual capabilities to the charger. This misrepresentation can cause chargers to either underutilize available power or attempt to draw more power than the source can provide, leading to suboptimal charging performance.

Moreover, some methods involve charge timers in battery packs. These timers require accurate current information to function properly. When the charger cannot provide this accurate information, the charge timers may trip prematurely, interrupting the charging process. Some methods struggle to maximize power delivery across the entire charging cycle. These methods may not adapt effectively to changing conditions, such as variations in power source output or the battery's changing needs as it charges.

Examples of the present disclosure provide a method for charging a battery pack that enhances power delivery while ensuring compatibility with various power sources and battery packs.

In some embodiments, a method of charging a battery pack includes receiving a current request, setting a charging setpoint based on the current request and a maximum output current; and configuring a converter based on the charging setpoint.

The method includes receiving a current request from the battery pack, the current request corresponds to the pack's power requirements. Based on the current request and a predetermined maximum output current, the method includes setting a charging setpoint. The charging setpoint is advantageous to determine the actual power to be delivered. The method includes configuring a power converter based on the charging setpoint.

To further enhance the charging process, the method may include measuring the actual current delivered to the battery pack using the power converter. The method may verify whether the intended current is being delivered based on the measured current. Based on the measurement current and the charging setpoint, the method can adjust the advertised maximum output current. This adaptive approach allowed enhanced performance of the charger based on real-time data. In some examples, the initial maximum output current may be set to the thermal maximum of the charging device. This approach causes the charger to start at a highest safe operating level, potentially enabling faster charging.

The method may also include receiving a request for maximum available current from the battery pack. The method may configure the converter to provide a current slightly above the requested current. This increase provides a buffer that can help detect when more power is available from the source, allowing for potential enhancement of the charging process.

To accommodate different stages of the charging cycle, some examples of the method include transitioning the converter from a constant power mode to a constant voltage mode when a predetermined battery voltage is reached.

In some examples, the method includes decreasing the advertised maximum output current based on the measured current being less than the requested current. The charger may therefore adapt to scenarios where the power source cannot provide the initially advertised current, ensuring safe and efficient charging even with variable or limited power sources.

According to some examples of the present disclosure, the charging system includes a power management controller. The power management controller may be configured to receive current requests from the battery pack, set the charging setpoint based on these requests and the maximum output current, and adjust the advertised maximum output current. The power management controller may continuously analyze data from other components to enhance the charging process.

A power converter may be a buck/boost converter. This converter delivers the requested current to the battery pack based on the charging setpoint determined by the power management controller. It's also capable of transitioning between constant power and constant voltage modes as the charging cycle progresses.

The charging system may include a current measurement module. The current measurement module measures the actual current being delivered to the battery pack in real-time. The current measurement module provides relevant data back to the power management controller, resulting in precise adjustments to the charging parameters.

Communication between the charger and the battery pack is facilitated by a dedicated communication interface. The communication interface receives current requests from the battery pack and advertises the charger's maximum output current capability.

The charging system may further include a thermal management component. This module monitors the temperature of the charging device and helps set the initial maximum output current based on the charger's thermal limits.

The charging system may include a mode transition module to manage the different stages of charging. The mode transition module monitors the battery voltage and initiates the transition from constant power mode to constant voltage mode when the battery reaches a predetermined voltage level, ensuring optimal charging throughout the cycle.

To handle varying power source capabilities, the charging system employs an adaptive current module. The adaptive current module compares the measured current to the requested current and can decrease the advertised current when the measured current falls short of the request.

The charging system may include a power source analyzer configured to assess the capabilities of the connected power source. The power source analyzer provides input to the power management controller to enhance the charging setpoint based on the actual capabilities of the power source, rather than relying solely on what the source may claim to provide.

Before any examples are explained in detail, it is to be understood that the examples are not limited in their application to the details of the configuration and arrangement of components set forth in the following description or illustrated in the accompanying drawings. The examples are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that examples may include hardware, software, and electronic components or modules that, for purposes of discussion, may be illustrated and described as when the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the examples. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some examples, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the examples will become apparent by consideration of the detailed description and accompanying drawings.

### BRIEF DESCRIPTION OF THE DRAWINGS

FIG. 1 illustrates an example power tool battery pack and battery pack charger according to some examples.

FIG. 2. illustrates a schematic of the battery pack charger of FIG. 1 according to some examples.

FIG. 3 illustrates a timing diagram of a method for charging a battery pack according to some examples.

FIG. 4 illustrates a flowchart of a method for charging a battery pack according to some examples.

FIG. 5 illustrates a flowchart of a method for charging a battery pack according to some examples.

### DETAILED DESCRIPTION

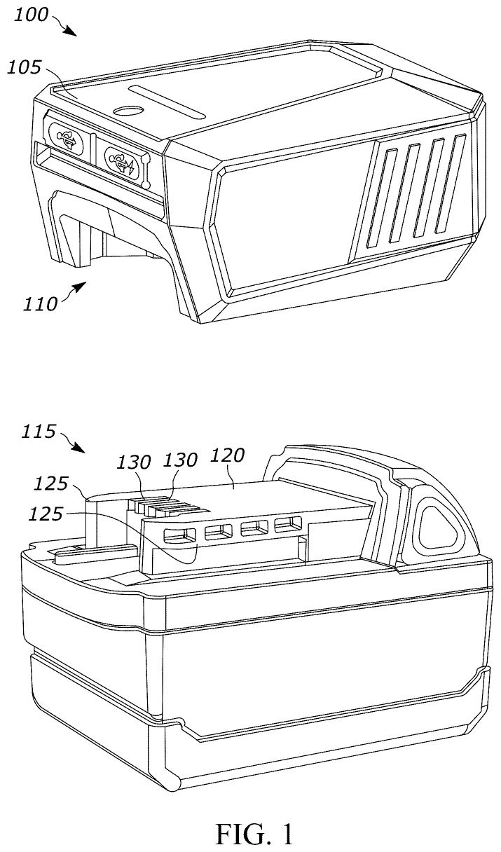

FIG. 1 illustrates an example battery pack charger 100. The battery pack charger 100 includes a charger housing 105, a battery pack interface 110 configured to removably receive a battery pack 115, and a user interface. In the embodiment shown, the battery pack interface 110 is provided on a bottom side of the charger housing 105 (e.g., on a first side of the charger housing 105). The battery pack interface 110 is configured to removably (e.g., slidably) receive the battery pack 115. Although not shown, the battery pack interface 110 includes a terminal block including terminals (e.g., power terminals and communication terminals) to connect to the corresponding battery pack terminal blocks of the battery pack 115. In some examples, the battery pack charger 100 may have a different configuration than illustrated in FIG. 1.

The battery pack 115 is, for example, power tool battery pack configured to be used to operate battery-powered power tools. In some examples, the battery pack 115 is an 18 volt nominal voltage lithium-ion-chemistry-based power tool battery pack. In other examples, the battery pack 115 may have a different nominal voltage (e.g., 12 volts, 36 volts, 72 volts, and the like) and different chemistry (e.g., nickel based). The battery pack 115 may include a connection portion 120 with two parallel, spaced apart rails 125 configured such that the battery pack 115 may be slidably engaged with a sliding-type battery pack interface of a power tool. The connection portion 120 also includes battery terminals 130 to electrically connect the battery pack 115 to charger terminals of the battery pack charger 100 or to another device, such as a power tool.

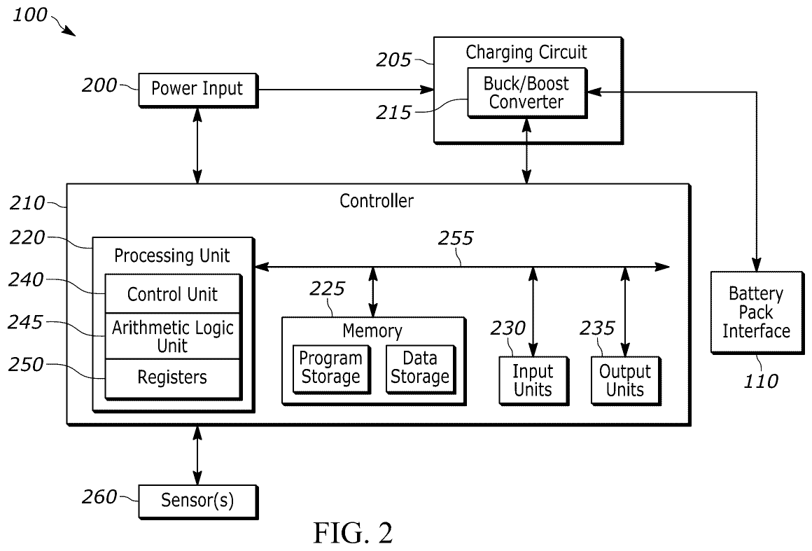

The battery pack charger 100 may include on or more power inputs (e.g., shown in FIG. 2, power input 200). The one or more power inputs include, for example, a power cord to connect to a wall outlet, a DC interface to connect to a solar panel, and/or the like. The DC interface includes, for example, a USB-C bi-directional power delivery interface. The DC interface may be used to connect to USB-C power sources to received charging power to charge the battery pack 115.

FIG. 2 illustrates a schematic of an example configuration of the battery pack charger 100. In the example shown, the battery pack charger 100 includes a power input 200, a charging circuit 205, a controller 210, and one or more sensors 260. The power input 200 includes, for example, a power cord that can be plugged into a wall outlet to receive power (such as, for example, external AC power) from an electrical grid or a power generator. The power input 200 may also include an interface to connect to a solar panel or other power source. The power input 200 is electrically connected to the charging circuit 205, which is electrically connected to the battery pack interface 110.

In one example, the charging circuit 205 includes an AC-DC converter (e.g., a rectifier) to convert AC power from the power input 200 into DC power and provide DC power to the battery pack 115. The charging circuit 205 also includes a buck/boost converter 215 to convert input power to an appropriate power (e.g., at a requested power) for charging the battery pack 115. The buck/boost converter 215 is, for example, a flyback converter or the like that can be controlled by the controller 210 to change the amount of current or power provided on a secondary side (i.e., output side) of the buck/boost converter 215. The one or more sensors 260 includes, for example, a current sensor or the like. The controller measures current flow of the battery pack charger 100 using the current sensor.

The controller 210 includes combinations of hardware and software that are operable to, among other things, control the operation of the battery pack charger 100. For example, the controller 210 includes, among other things, a processing unit 220 (e.g., a microprocessor, a microcontroller, an electronic processor, an electronic controller, or another suitable programmable device), a memory 225, input units 230, and output units 235. The processing unit 220 includes, among other things, a control unit 240, an arithmetic logic unit (“ALU”) 245, and a plurality of registers 250 (shown as a group of registers in FIG. 2) and is implemented using a known computer architecture (e.g., a modified Harvard architecture, a von Neumann architecture, etc.). The processing unit 220, the memory 225, the input units 230, and the output units 235, as well as the various modules or circuits connected to the controller 210 are connected by one or more control and/or data buses (e.g., common bus 255). The control and/or data buses are shown generally in FIG. 2 for illustrative purposes. Although the controller 210 is illustrated in FIG. 2 as one controller, the controller 210 could also include multiple controllers configured to work together to achieve a desired level of control for the battery pack charger 100. As such, any control functions and processes described herein with respect to the controller 210 could also be performed by two or more controllers functioning in a distributed manner.

The memory 225 is a non-transitory computer readable medium and includes, for example, a program storage area and a data storage area. The program storage area and the data storage area can include combinations of different types of memory, such as a read only memory (“ROM”), a random access memory (“RAM”) (e.g., dynamic RAM [“DRAM”], synchronous DRAM [“SDRAM”], etc.), electrically-erasable programmable ROM (“EEPROM”), flash memory, a hard disk, an SD card, or other suitable magnetic, optical, physical, or electronic memory devices. The processing unit 220 is connected to the memory 225 and is configured to execute software instructions that are capable of being stored in a RAM of the memory 225 (e.g., during execution), a ROM of the memory 225 (e.g., on a generally permanent basis), or another non-transitory computer readable medium such as another memory or a disc. Software included in the implementation of the battery pack charger 100 and controller 210 can be stored in the memory 225 of the controller 210. The software includes, for example, firmware, one or more applications, program data, filters, rules, one or more program modules, and other executable instructions. The controller 210 is configured to retrieve from the memory 225 and execute, among other things, instructions related to the control processes and methods described herein. In other embodiments, the controller 210 includes additional, fewer, or different components.

The battery pack charger 100 includes additional components that are omitted from the figures and this description for simplifying the description. For example, the battery pack charger 100 may include outlets to power external devices using power from the battery pack 115. Additionally, the battery pack charger 100 may include various FETs and gate driver to control the FETs. For example, a charging FET may be connected between the charging circuit 205 and the battery pack interface 110.

The battery pack charger 100 and the battery pack 115 communicate to negotiate power requirements during charging. The available power (e.g., maximum current) to a battery pack charger 100 for charging the battery pack 115 may change over time. For example, the available power for charging may change based on the amount of incident sunlight on a solar panel connected to a USB-C interface of the battery pack charger 100. The battery pack charger 100 and the battery pack 115 communicate iteratively to negotiate charging current requirements based on the available power for charging.

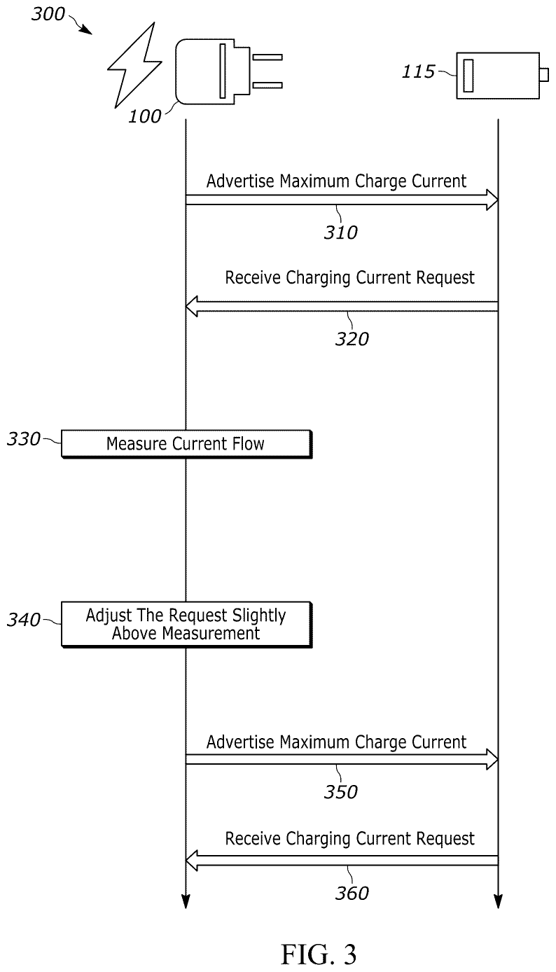

FIG. 3 illustrates a timing diagram 300 showing the negotiation between the battery pack charger 100 and the battery pack 115. The battery pack charger 100 advertises a maximum charging current to the battery pack 115 (at block 310). The controller 210 may detect that a battery pack 115 is connected to the battery pack interface 110. In response, the controller 210 communicates an initial maximum charging current to the battery pack 115. The controller 210 may determine the maximum charging current based on communication with, for example, a power source (e.g., a solar panel). The controller 210 may set the maximum charging current to a value received from the power source.

The battery pack charger 100 receives a charging current request from the battery pack 115 (at block 320). The battery pack 115 charging current request may be equal to the maximum charging current or below the maximum charging current. In one example, the battery pack 115 may request charging current equal to the maximum charging current when the maximum charging current is equal to or less than the maximum current at which the battery pack 115 is capable of being charged. The battery pack 115 may request charging current less than the maximum charging current when the maximum charging current is greater than the maximum current at which the battery pack 115 is capable of being charged. As explained below, the controller 210 configures the buck/boost converter 215 to provide a charging current (e.g., current flow) to the battery pack 115.

The battery pack charger 100 measures current flow (at block 330). The controller 210 measures the current using, for example, a current sensor. The controller 210 may then compare the measured current to the requested charging current to determine whether the negotiated charging current is being provided to the battery pack 115. The battery pack charger 100 may increase the current provided to the battery pack 115 slightly above the requested current to determine whether the battery pack charger 100 is capable of providing higher power (at block 340).

The battery pack charger 100 re-advertises the maximum charging current to the battery pack 115 (at block 350). The controller 210 may reset the maximum charging current to a new value received from the power source and/or based on the measured current flow. The controller 210 then provides the maximum charging current to the battery pack 115. The battery pack charger 100 receives a new charging current request from the battery pack 115 based on the maximum charging current (at block 360).

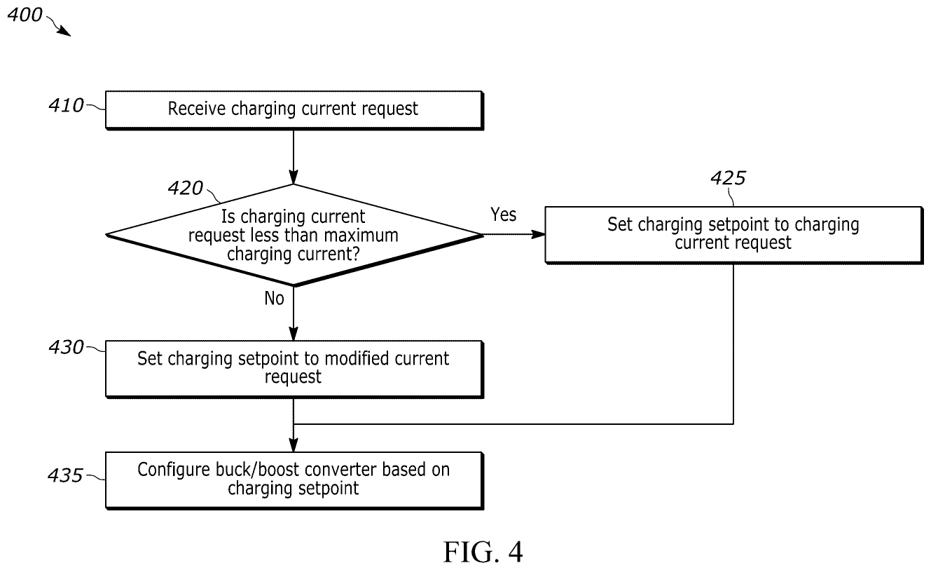

FIG. 4 is a flowchart of an example method 400 for charging the battery pack 115. The method 400 may be implemented by the controller 210. In the example illustrated, the method 400 includes receiving, from the battery pack 115, a charging current request (at block 410). The controller 210 advertises a maximum charging current to the battery pack 115, for example, after an initial connection of the battery pack 115 to the battery pack charger 100. The charging current request may be received in response to the advertisement of the maximum charging current from the battery pack 115.

The method 400 includes determining, using the controller 210, whether the charging current request is less the maximum charging current (at block 420). The controller 210 compares the requested current to the advertised current to determine whether the requested current is less than the advertised current. The method 400 includes setting, using the controller 210, a charging setpoint to the charging current request when the charging current request is less than the maximum charging current (at block 430). The method 400 further includes setting, using the controller 210, the charging setpoint to a modified current when the charging current request is not less than the maximum charging current (at block 440). The modified current is, for example, an offset greater than requested current (i.e., I_{request}+I_{offset}).

The method 400 includes configuring, using the controller 210, the buck/boost converter 215 based on the charging setpoint (at block 450). The charging setpoint may be set in block 430 or block 440. The controller 210 configures and/or controls the buck/boost converter 215 based on the charging setpoint. For example, the controller 210 may perform a PWM control on a switch (e.g., a FET of a flyback converter) to adjust the amount of current provided to the battery pack 115 according to the charging setpoint. The controller 210 may further clamp the current output of the battery pack charger 100 to a thermal maximum current. The thermal maximum current is preset maximum current of the battery pack charger 100 irrespective of the power available from the power source. Keeping the current below the thermal maximum current may reduce the likelihood of a thermal failure of the battery pack charger 100. The method 400 returns to block 410 to iteratively negotiate power requirements with the battery pack 115 as discussed above.

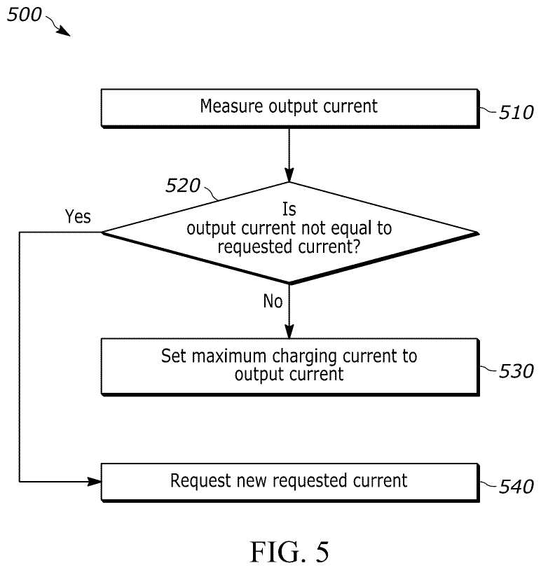

FIG. 5 illustrates a flowchart of an example method 500 for charging the battery pack 115. The method 500 may be implemented by the controller 210, for example, after block 450 and before the method 400 returns to block 410. In the example illustrated, the method 500 includes measuring, using a sensor, an output current of the battery pack charger 100 (at block 510). The controller 210 may use the current sensor to measure the output current to the battery pack 115. The method 500 includes determining, using the controller 210, whether the output current does not equal the requested current (at block 520). The controller 210 may determine whether the output current is within a tolerance level of the requested current.

The method 500 includes setting, using the controller 210, the maximum charging current to the output current when the output current is not equal to the requested current (at block 530). The controller 210 may replace the value of the maximum charging current with a new value of the measured output current. That is, the controller 210 may decrease the advertised maximum current to the output current based on the output current being less than the requested current. The method 500 includes requesting, from the battery pack 115, new charging current request (at block 540). The controller 210 requests new charging current after block 530 and/or when the measured output current is equal to (e.g., within a tolerance) of the requested current. For example, the controller 210 may return to block 410 of method 400.

Thus, embodiments described herein provide, among other things, a battery pack charger and method for adaptive battery pack charging.

What is claimed is:

1. A method for charging a battery pack, comprising:
receiving, using a controller of a battery pack charger, a current request;
setting, using the controller, a charging setpoint based on the current request and an advertised maximum current; and
configuring, using the controller, a converter of the battery pack charger based on the charging setpoint.

2. The method of claim 1, further comprising:
measuring, using a current sensor of the battery pack charger, an output current; and
adjusting, using the controller, the advertised maximum current based on the output current and the charging setpoint.

3. The method of claim 2, wherein adjusting the advertised maximum current comprises:
decreasing, using the controller, the advertised maximum current in response to the output current being less than the requested current.

4. The method of claim 1, wherein the advertised maximum current is set to a thermal maximum current.

5. The method of claim 1, further comprising:
receiving, using the controller, the advertised maximum current from a power source.

6. The method of claim 1, further comprising:
setting, using the controller, the charging setpoint to a value above the requested current based on the requested current being equal to the advertised maximum current.

7. The method of claim 1, wherein the converter is a flyback converter.

8. The method of claim 7, further comprising:
performing, using the controller, a PWM control on a switch of the converter to adjust an amount of current provided to the battery pack.

9. A battery pack charger comprising:
a device housing;
a power input;
a battery pack interface provided on the device housing and configured to removably receive a battery pack;
a converter electrically connected between the power input and the battery pack interface; and
a controller electrically connected to the power input, the battery pack interface, and the converter and configured to:
receive a current request;
set a charging setpoint based on the current request and an advertised maximum current; and
configure the converter based on the charging setpoint.

10. The battery pack charger of claim 9, wherein the controller is further configured to:
measure, using a current sensor, an output current; and
adjust the advertised maximum current based on the output current and the charging setpoint.

11. The battery pack charger of claim 10, wherein the controller is configured to:
decrease the advertised maximum current based on the output current being less than the requested current.

12. The battery pack charger of claim 9, wherein the advertised maximum current is set to a thermal maximum current.

13. The battery pack charger of claim 9, wherein the controller is configured to:
receive the advertised maximum current from a power source.

14. The battery pack charger of claim 9, wherein the controller is further configured to:
set the charging setpoint to a value above the requested current based on the requested current being equal to the advertised maximum current.

15. The battery pack charger of claim 9, wherein the converter is a flyback converter.

16. The battery pack charger of claim 15, wherein the controller is configured to:
perform a PWM control on a switch of the converter to adjust an amount of current provided to the battery pack.

17. A battery pack charger comprising:
a device housing;
a power input configured to be connected to a power source;
a battery pack interface provided on the device housing and configured to removably receive a battery pack;
a converter electrically connected between the power input and the battery pack interface; and
a controller electrically connected to the power input, the battery pack interface, and the converter and configured to:
determine a maximum charging current based on communication with the power source;
receive a charging current request from the battery pack;
set a charging setpoint based on the maximum charging current and the charging current request;
configure the converter based on the charging setpoint;
measure, using a current sensor, an output current of the battery pack charger; and
adjust the maximum charging current based on the output current.

18. The battery pack charger of claim 17, wherein the controller is configured to:
decrease the maximum charging current based on the output current being less than the charge current request.

19. The battery pack charger of claim 17, wherein the controller is further configured to:
set the charging setpoint to a value above the requested current based on the requested current being equal to an advertised maximum current.

20. The battery pack charger of claim 17, wherein the power input is a USB-C power delivery interface.
